(19) United States
(12) Patent Application Publication
(10) Pub. No.: US 2007/0017329 A1
(43) Pub. Date: Jan. 25, 2007

(54) Punching die for manufacturing a holding seal member, and method for manufacturing a holding seal member with a punching die

(76) Inventor: Shiro Osumi, Takahama-shi (JP)

Correspondence Address: MARSH, FISCHMANN & BREYFOGLE LLP, 3151 SOUTH VAUGHN WAY, SUITE 411, AURORA, CO, 80014, US

(21) Appl. No.: 11/400,780

(22) Filed: Apr. 6, 2006

(30) Foreign Application Priority Data
Jul. 25, 2005 (JP) 2005-215053

(51) Int. Cl. B26D 1/00; B26D 5/08

(52) U.S. Cl. 83/13; 83/613

(57) ABSTRACT

A punching die for punching a sheet of inorganic fiber mat to manufacture a holding seal member for winding around an exhaust gas purifier body. The punching die includes a base plate. A double-edged punching blade, supported by the base plate, punches the inorganic fiber mat to cut out the holding seal member.

### CROSS-REFERENCE TO RELATED APPLICATIONS

This application is based upon and claims the benefit of priority from prior Japanese Patent Application No. 2005-215053, filed on Jul. 25, 2005, the entire contents of which are incorporated herein by reference.

### BACKGROUND OF THE INVENTION

The present invention relates to a punching die for use in manufacturing a holding seal member for winding around an exhaust gas purifier body, and to a manufacturing method for a holding seal member employing such a punching die.

An exhaust gas treatment apparatus for use in a vehicle is normally located in the middle of an exhaust passage in a vehicle. A diesel particulate filter (DPF) and an exhaust gas purifying catalyst converter, which removes graphite particles referred to as particulates, are known in the prior art as examples of an exhaust gas treatment apparatus. A typical exhaust gas treatment apparatus includes an exhaust gas purifier body, a metal pipe (shell) enclosing the exhaust gas purifier body, and a holding seal member filling the gap between the exhaust gas purifier body and the metal pipe.

The holding seal member must function to prevent the exhaust gas purifier body from being broken when hit against the metal pipe due to vibrations of the vehicle. The holding seal member must also function to prevent the exhaust gas purifier body from falling off from the metal pipe or dislodging in the metal pipe when subjected to exhaust gas pressure. Further, the holding seal member must prevent the exhaust gas from leaking out of the gap between the metal pipe and the exhaust gas purifier body.

A conventional holding seal member is produced by cutting a fiber mat having a uniform thickness (refer to JP-A-2001-316965). Scissors, knives, or punching blades (Thomson blades) are used for cutting the fiber mat.

### SUMMARY OF THE INVENTION

The use of scissors or knives requires a long time for cutting a holding seal member out of a sheet of fiber mat. The conventional punching die does not have sufficient durability for continuously punching out holding seal members.

One aspect of the present invention is a punching die for punching a sheet of an inorganic fiber mat to manufacture a holding seal member for winding around an exhaust gas purifier body. The punching die includes a base plate. A double-edged punching blade, supported by the base plate, punches the inorganic fiber mat to cut out the holding seal member.

A further aspect of the present invention relates to a method for manufacturing a holding seal member for winding around an exhaust gas purifier body from a sheet of inorganic fiber mat. The method includes forming a punching die by supporting a double-edged punching blade on a base plate, and using the punching die to punch the inorganic fiber mat to form a holding seal member.

In one embodiment, the punching blade includes two side surfaces, two inclination surfaces inclined relative to the two side surfaces, and a cutting edge defined between the two inclined surfaces. The two inclined surfaces are inclined at the same or different inclination angles.

In one embodiment, the inclination angles of the two inclined surfaces are both about ten to about thirty degrees.

In one embodiment, the difference between the inclination angles of the two inclined surfaces is about ten degrees or less.

In one embodiment, the punching blade is made of carbon steel.

In one embodiment, the inorganic fiber mat is made of alumina fibers.

In one embodiment, the punching blade is lattice-shaped and cuts out a plurality of holding seal members from the inorganic fiber mat in a single punch.

In one embodiment, the punching blade includes a plurality of parallel and straight longitudinal blades, a plurality of lateral blades intersecting the longitudinal blades at a right angle and bent to form a tab and a socket for receiving the tab in each of the holding seal members. The longitudinal blades and the lateral blades are welded together.

In one embodiment, the plurality of longitudinal blades and the plurality of lateral blades have the same height.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1A is a bottom view of a punching die according to a preferred embodiment of the present invention;

FIG. 1B is a partially enlarged view of FIG. 1A;

FIG. 2 is a cross-sectional view taken along line 2-2 in FIG. 1A.

FIG. 3A is an enlarged view showing a symmetric cutting edge;

FIG. 3B is an enlarged view showing an asymmetric cutting edge;

FIGS. 4A to 4D are cross-sectional views showing the punching of an inorganic fiber mat with the punching die shown in FIG. 1A; and

FIG. 5 is a partially cutaway perspective view of an exhaust gas purifier assembly having a holding seal member of the preferred embodiment.

### DESCRIPTION OF THE PREFERRED EMBODIMENTS

A punching die 11 according to a preferred embodiment of the present invention will now be described with reference to the accompanying drawings.

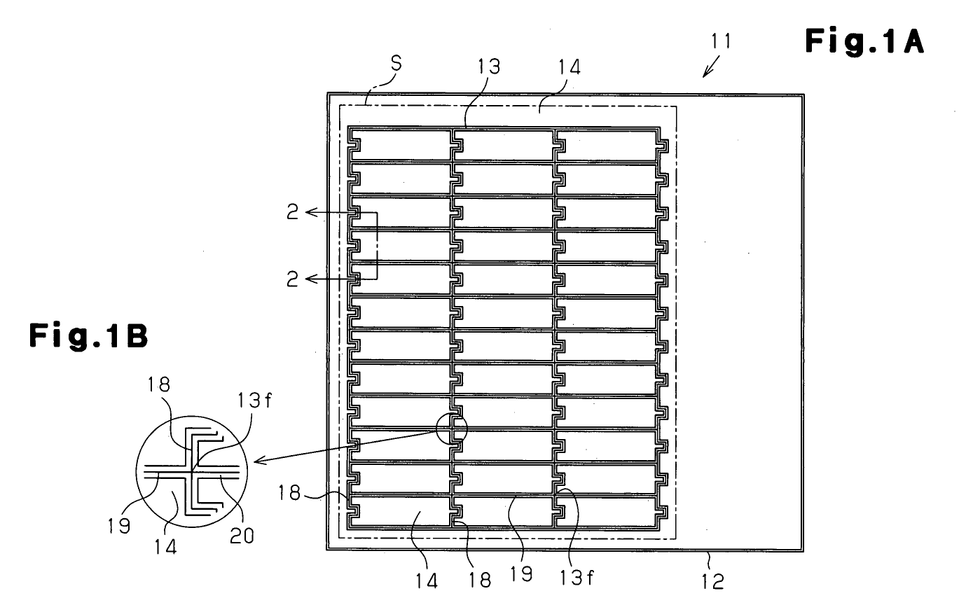

As shown in FIG. 1A, the punching die 11 includes a base plate 12, a plurality of punching blades 13 supported by the base plate 12, and elastic members 14 attached to the base plate 12. The elastic members 14 are elastically deformed in a reversible manner when pressed. The punching die 11 punches a sheet of an inorganic fiber mat 16 to cut out a holding seal member 15 for winding around a filter member 42, which functions as an exhaust gas purifier body.

The punching die 11 of the preferred embodiment cuts out a plurality of holding seal members 15 from a sheet of inorganic fiber mat 16. The holding seal member 15 is strip-shaped and has a tab 15b and a socket 15a. The holding seal member 15 has a uniform thickness.

The inorganic fiber mat 16 has a uniform thickness and is formed from a felt or nonwoven fabric having a uniform resilience. The inorganic fiber mat 16 is preferably made of ceramic fibers such as silica fibers, alumina fibers, mixed fibers of silica and alumina, and glass fibers. The inorganic fiber mat 16 may be impregnated with an organic binder before the cutting to give the mat a predetermined thickness and repulsive force. The organic binder may be a water-soluble resin such as acrylic resin or polyvinyl alcohol, or latex such as acrylic rubber or nitrile rubber. The thickness of the holding seal member 15 is determined in accordance with the type of the inorganic fiber mat 16, the type of catalyst carrier, and the type of exhaust gas purifier body. The inorganic fiber mat 16 may be needle-punched for reducing bulkiness (thickness).

The base plate 12 is made of wood or plywood such as veneer. The base plate 12 has a processing surface 12a. The punching blades 13 project orthogonally from the processing surface 12a. The processing surface 12a of the base plate 12 is arranged in parallel with a support table 17 supporting the inorganic fiber mat 16 during the punching operation. The base plate 12 reciprocates toward and away from the support table 17. The punching blades 13 cut out a plurality of holding seal members 15 from the inorganic fiber mat 16, which is located at a punching area S, through a single punching operation. The size of the base plate 12 is determined in accordance with the size of the punching area S. Blade grooves 12b are formed in the processing surface 12a of the base plate 12 to receive the basal ends 13b of the punching blades 13. The blade grooves 12b are formed through, for example, laser processing.

The punching blades 13 are fabricated by bending a metal band in accordance with the shape of the holding seal members 15. The punching blades 13 each have a cutting edge 13a shaped in accordance with the holding seal member 15 and a basal end 13b inserted into the blade groove 12b. The punching blades 13 are, for example, lattice-shaped and include connection end formation blades (lateral blades) 18, which form the sockets 15a and tabs 15b of the holding seal members 15, side formation blades (longitudinal blades) 19, which form longitudinal sides of the holding seal members 15. Each lateral blade 18 has a cutting edge which is bent in accordance with the shape of the sockets 15a and the tabs 15b. Each longitudinal blade 19 has a linear, straight cutting edge. The lateral blades 18 and the longitudinal blades 19 are welded together at a plurality of joints 13f. During a single punching operation, each lateral blade 18 forms a connection end, or a socket 15a, in one of two adjacent holding seal members 15, and a connection end, or a tab 15b, in the other one of the two adjacent holding seal members 15. Each longitudinal blade 19 forms the longitudinal sides of two adjacent holding seal members 15 at the same time. Thus, a plurality of holding seal members 15 and the remaining peripheral portion are cut out from a sheet of inorganic fiber mat 16 by the punching blades 13. When using the punching die 11 shown in FIG. 1, thirty-six holding seal members 15 may be formed simultaneously.

While the thickness of the punching blades 13 is not limited to any specific value, the thickness is about 0.5 through about 1.5 mm, preferably about 0.8 through about 1.2 mm, and more preferably about 1.0 mm. The punching blades 13 have high durability and resist breakage when having a thickness of about 0.5 mm or more. When the thickness is about 1.5 mm or less, the punching blades 13 may easily be formed by bending a metal band without affecting the shape of the holding seal members 15. Each cut-out holding seal member 15 will not be caught tightly between the punching blades 13 enclosing each holding seal member 15 if the punching blades 13 have the proper thickness. Accordingly, the cut-out holding seal members 15 can be easily pushed out of the punching die 11 by the elastic members 14. The height (h) from the processing surface 12a of the base plate 12 to the cutting edge 13a of each punching blade 13 is determined in accordance with the thickness and material of the holding seal members 15.

As shown in FIG. 3A, the punching blade 13, which is double-edged, includes two side surfaces 13e1 and 13e2, two inclined surfaces 13c and 13d respectively inclined to the two side surfaces 13e1 and 13e2, and a cutting edge 13a defined by the two inclined surfaces 13c and 13d. The two inclined surfaces 13c and 13d are respectively inclined at inclination angles θ1 and θ2. The inclination angles θ1 and θ2 are the same or about the same. More specifically, the difference between the inclination angles θ1 and θ2 is about ten degrees or less, preferably about five degrees of less, and more preferably about zero degrees. As long as the angle difference is ten degrees or less, the cutting edge 13a of the punching blade 13 will not be bent to the side of which inclination angle is smaller when pressed against the inorganic fiber mat 16. Thus, the punching blade 13 may be used to perform successive punching. Further, a plurality of the holding seal member 15 may be cut out without dimensional errors. FIG. 3B shows a punching blade 13 in which inclination angle θ3 is less than inclination angle θ4. The cutting edge 13a is deviated from a center line T of the cutting edge 13a toward the side surface 13e1 (the side surface of which inclination angle is small). In this case, the punching load applied to the cutting edge 13a differs between the side of the inclined surface 13c and the side of the inclined surface 13d.

The inclination angles θ1 and θ2 are preferably about 10 to about 30 degrees, preferably about 15 to about 25 degrees, and more preferably about 17 to about 22 degrees. As long as the inclination angles θ1 and θ2 are about 10 degrees or greater, the cutting edge 13a would not be too sharp or too thin. Thus, the application of load produced when punching the inorganic fiber mat 16 having a predetermined thickness and repulsion force would not damage the cutting edge 13a. Further, as long as the inclination angles θ1 and θ2 are about 30 degrees or less, the cutting edge 13a is sharp enough to completely cut the inorganic fiber mat 16 . Also, the cutting edge 13a would not be damaged when receiving the load produced when punching the inorganic fiber mat 16. As long as the inclination angle is within the above range, the inclination angles θ1 and θ2 may be the same or different.

Examples of material for the punching blade 13 include steels such as carbon steel, stainless steel, molybdenum steel, and special steel (alloy steel); alloys such as cobalt alloy (stellite), and titanium alloy; and fine ceramics such as zirconia and alumina. Steels that can be heat treated to increase hardness are preferable. Particularly, carbon steel is preferable since it has a relatively high hardness and durability and can easily be obtained. Further, the mechanical characteristics of carbon steel may be varied in accordance with its purpose of use by changing the content rate of carbon. Carbon steel is an alloy of steel and carbon and has a carbon (C) content rate of 2% or less. Further, carbon steel contains a slight amount of silicon, manganese, phosphor, and sulfur. Carbon steel is classified into dead soft steel having a carbon content rate of about 0.12% or less, low carbon steel (soft steel) having a carbon content rate of about 0.12% to about 0.2%, medium carbon steel (semi-soft steel, semi-hard steel) having a carbon content rate of about 0.2% to about 0.45%, high carbon steel (hard steel) having a carbon content rate of about 0.45% to about 0.8%, and extra hard steel having a carbon content rate of about 0.8 to about 1.7%. A higher carbon content rate increases the hardness that is obtained through heat treatment. A lower carbon content rate increases rust resistance. The amount of carbon in carbon steel is determined in accordance with the material and purpose of the inorganic fiber mat 16. The punching blade 13 may be manufactured from a grad material obtained by bonding a plurality of metal materials. For example, carbon steel having a high carbon content rate may be selectively used for the cutting edge 13a. In this case, the cutting edge 13a that is obtained is hard. Layers of carbon steel having a low carbon content rate may be laminated on the two side surfaces 13e1 and 13e2. Such a triple layer structure would improve the rust resistance of the punching blade 13. Carbon steel having a low carbon content rate may be used at bent portions of the punching blade 13. This would enable easy bending of the punching blade 13 and facilitate manufacturing. If the inorganic fiber mat 16 is made of alumina fibers, it is preferable that carbon steel having a high carbon content rate be used as the material of the punching blade 13.

The elastic members 14 are attached to the processing surface 12a of the base plate 12. The elastic members 14 push out each holding seal member 15 enclosed and held by the punching blades 13 towards the support table 17 when the punching blades 13 are moved away from the support table 17. The elastic members 14 are elastic layers having a uniform thickness (t). The thickness (t) is preferably greater than the height (h) of the punching blades. If the thickness (t) of the elastic members 14 is less than the height (h) of the punching blades 13, wear will occur in the elastic members 14 due to repetitive punching operations. In such a case, the holding seal members 15 will not be sufficiently pushed out. However, if the thickness of the elastic members 14 is much greater than the height (h) of the punching blades 13, this would cause compressive deformation of the holding seal members 15. Therefore, the thickness of the elastic members 14 should be varied in accordance with the thickness of the holding seal members 15 and the height of the punching blades 13. Preferably, the thickness of the elastic members 14 is set to about 10 mm or less, and more preferably, to about 3 to about 7 mm.

The material for the elastic members 14 is not especially limited as long as it is an elastic material that is elastically deformed in a reversible manner when pressed. The material for the elastic members 14 , for example, may be nonwoven fabric or felt made of organic or inorganic fibers, or foam made of an expandable material. When using foam, fibers do not become entangled in the holding seal members. Foams usable for the elastic members 14 include polyurethane foam, polyester foam, melamine resin foam, phenolic resin foam, polyethylene foam, polypropylene foam, polystyrene foam, natural rubber foam, synthetic rubber foam, and elastomeric foam. The elastic members 14 may be made from either a single elastic material or a combination of two or more elastic materials. The elastic members 14 may be made of either a single layer or laminated layers of the same or different elastic materials.

The present inventors have checked the wear rate for various elastic materials. The wear rate for each elastic material was computed by measuring the reduction percentage in compression load before and after the elastic material was compressed and decompressed repeatedly for 100 times. A low wear rate indicates that the material is restorable to its original shape. The results show that synthetic rubber foam exhibited the lowest wear rate when subjected to the repeated compression. Consequently, it is most preferable that the elastic members 14 be made of synthetic rubber foam. It is preferable that the wear rate of the elastic members 14 be lower. The wear rate for synthetic rubber foam was about 2% or less. An elastic material having a high wear rate will be compressed in an irreversible manner through successive punching operations. Thus, the holding seal members 15 will not be sufficiently pushed out.

The compression load deflection at 25% for the elastic members 14 is about 25 through about 120 kPa, preferably about 30 through about 100 kPa, and more preferably about 40 through about 60 kPa. The compression load deflection at 25% was measured in accordance with American Society For Testing and Materials (ASTM) D1056. Elastic members having a compression load deflection at 25% of about 25 to about 120 kPa will generate enough repulsive force to push out the holding seal members 15 held by the punching blades 13 and will be soft enough so that it does not change the characteristics or shape of the holding seal members 15 during punching.

The punching blades 13 define a plurality of partitioned sections, each having the shape of the holding seal members 15. The elastic members 14 are arranged within the partitioned sections on the processing surface 12 a of the base plate 12. The elastic members 14 are also arranged at the outer side of the punching blades 13 on the processing surface 12a. The elastic members 14 located in the partitioned sections function to push out the holding seal members 15, which have been pressed into the partitioned sections, from the punching die 11. The elastic member 14 located outside the punching blades 13 push out the peripheral portion of the punched inorganic fiber mat 16 from the punching die 11.

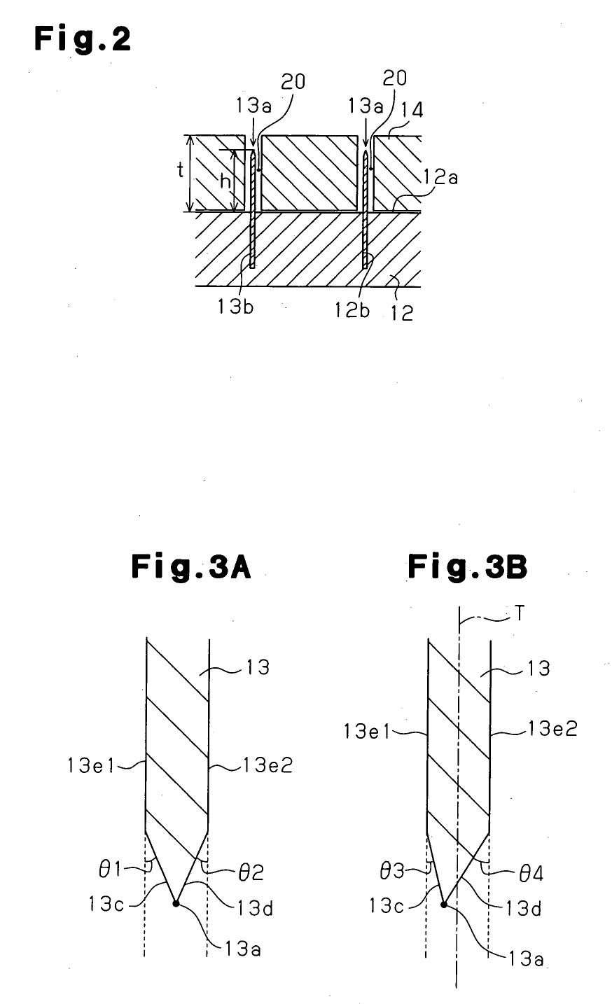

The elastic members 14 are adhered to substantially the entire processing surface 12a, except for where the punching blades 13 are located, with a two-sided adhesive tape or an adhesive agent. As shown in FIG. 2, the elastic members 14 preferably do not contact the punching blade 13 . Preferably, each of the elastic members 14 is separated from the side surface of the punching blade 13 by a distance of about zero to about 10 mm to define gap 20 therebetween. If the gap 20 is about 10 mm or greater, the holding seal members 15 will be apt to catch in the gap 20 and will become difficult to be forced out of the gap 20. This may result in deformation of the holding seal members 15. If the gap 20 is greater than about zero mm, the repulsive force of the elastic member 14 would not be reduced by frictional resistance between the side surface of elastic member 14 and the side surface of the punching blade 13. More preferably, the gap 20 is about five 5 mm. If the gap 20 is about five mm, the repulsive force of the elastic member 14 would not be reduced by frictional resistance between the side surfaces of the elastic member 14 and the punching blade 13. Moreover, the repulsive force of the elastic member 14 will act on substantially the entire surface of the holding seal member 15.

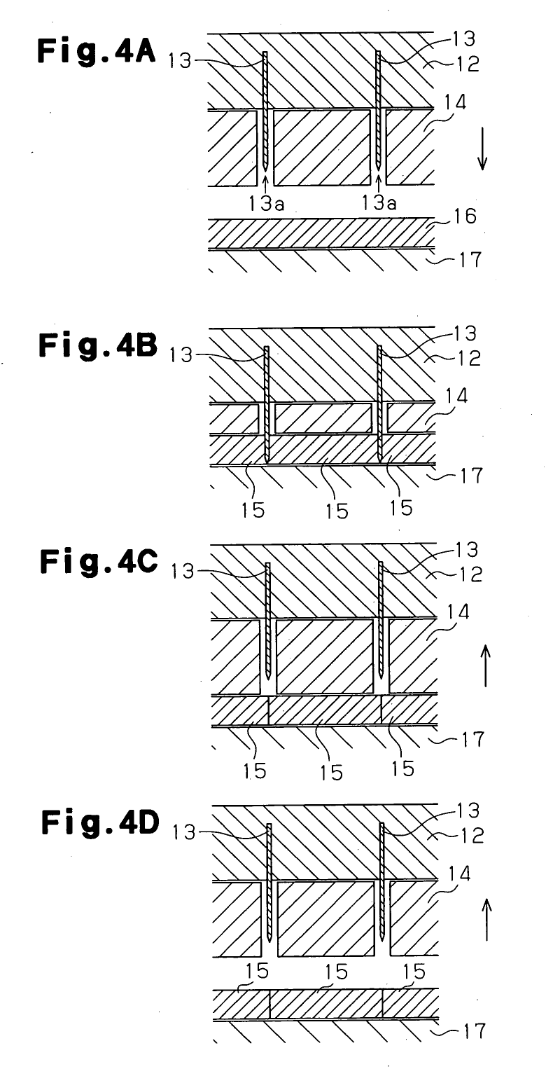

The operation of the punching die 11 will now be described with reference to FIGS. 4A to 4D.

An inorganic fiber mat 16 having a predetermined thickness and repulsive force is placed on the support table 17. The inorganic fiber mat 16 is positioned in the punching area S of the punching die 11. The punching die 11 is lowered while being kept parallel with the support table 17 (FIG. 4A). During the lowering of the punching die 11, the elastic members 14 first come into contact with the inorganic fiber mat 16. The inorganic fiber mat 16 is thus held between the elastic members 14 and the support table 17. As the punching die 11 is further lowered, the elastic members 14 are compressed and the cutting edges 13a of the punching blades 13 come into contact with the upper surface of the inorganic fiber mat 16. From this state, when the punching die 11 is further lowered, the cutting edges 13a of the punching blades 13 come into contact with the support table 17 and the holding seal members 15 are cut out from the inorganic fiber mat 16. The holding seal members 15 are pressed into the partitioned sections and compressed for an amount corresponding to the thickness of the punching blades 13. When the punching die 11 is raised (FIG. 4C), the holding seal members 15 are pushed out (released) from the partitioned sections by the repulsive force of the elastic members 14. By this time, the cutting edges 13a of the punching blades 13 have been moved away from the inorganic fiber mat 16. However, the inorganic fiber mat 16 is still held between the elastic members 14 and the support table 17. This keeps the inorganic fiber mat 16 in its original shape as before the punching. Furthermore, the plurality of holding seal members 15 and the peripheral portion of the inorganic fiber mat 16 obtained by the punching are kept in a neatly arranged manner and are not scattered apart. The punching die 11 is further raised until the elastic members 14 are moved away from the inorganic fiber mat 16 (FIG. 4D). The support table 17 is then conveyed to the next process. The lowering and raising of the punching die 11 may be performed in cooperation with the movement of a belt conveyor conveying the support table 17. In this case, the punching die 11 may consecutively punch the inorganic fiber mat 16.

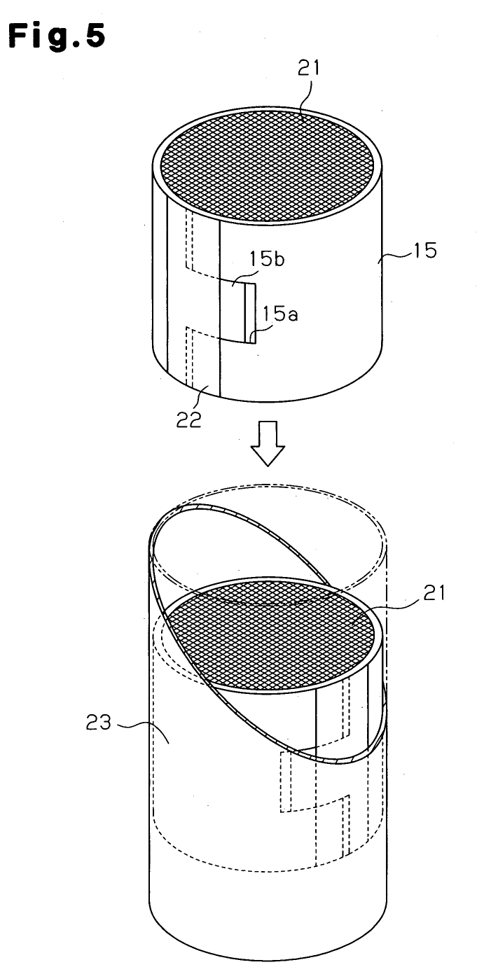

The assembling of the exhaust gas treatment apparatus will now be described with reference to FIG. 5. In the first step, a holding seal member 15 is wound around an exhaust gas purifier body such as a catalyst carrier 21. The tab 15b is fitted in the socket 15a of the holding seal member 15. In this manner, the holding seal member 15 can be wound around the entire circumference of the catalyst carrier 21 without the ends of the holding seal member 15 overlapping each other.

The catalyst carrier 21, to which the holding seal member 15 is wound around, is pressed into a tubular metal shell 23. The holding seal member 15 is elastically compressed when pressed into the tubular shell 23. The catalyst carrier 21 is held in the tubular shell 23 by the repulsive force of the holding seal member 15. The holding seal member 15 also functions as a protective cushion preventing the catalyst carrier 21 from being hit against the tubular shell 23 by vibrations transmitted from the outer side.

The preferred embodiment has the advantages described below.

(1) The punching blade 13 is a double-edged blade having a cutting edge 13a defined between the inclined surfaces 13c and 13d respectively inclined to the two side surfaces 13e1 and 13e2. The cutting edge 13a resists deformation and the punching blade 13 has high durability.

(2) The difference between the inclination angles θ1 and θ2 of the inclined surfaces 13c and 13d is about ten degrees or less. This prevents the punching load acting on the cutting edge 13a from differing greatly between the side of the inclined surface 13c and the side of the inclined surface 13d. Thus, the punching blade 13 has sufficient durability for consecutively cutting out holding seal members 15.

(3) When the inclination angles θ1 and θ2 are substantially the same, the cutting edge 13a is located at a generally median position T with respect to the thickness of the punching blade 13. In this case, the punching blade 13 has a high cutting accuracy and cuts out two adjacent holding seal members 15 with the same dimensions and shapes.

(4) When the material of the punching blade 13 is carbon steel, the punching blade 13 has superior hardness and durability. For example, the inorganic fiber mat 16, which is bulky and made of alumina fibers, produces sufficient repulsive force for holding a catalyst carrier. The use of carbon steel having a high carbon content rate and thus having superior durability and hardness is especially effective for the consecutive punching of such an inorganic fiber mat 16.

(5) The inorganic fiber mat 16 placed on the support table 17 is positioned to face the punching blades 13 immediately before a punching operation. This prevents production of defective holding seal members.

(6) When the base plate 12 is made of wood, the blade grooves 12b may easily be formed.

(7) A holding seal member 15 cut out by the punching die 11 has uniform cut surfaces and a uniform thickness. Thus, the socket 15a and the tab 15b are identically shaped. This manufactures the holding seal member 15 so that it perfectly fits into the catalyst carrier 21.

The preferred embodiment may be modified as described below.

The base plate 12 may be made of a metal material.

The blade grooves 12b may be formed partially or entirely in the processing surface 12a of the base plate 12 in correspondence with the punching blades 13. The punching blades 13 may each be fastened to the base plate 12 by a fastener such as a screw or a bolt.

A through hole may be formed in the base plate 12 to communicate with the blade groove 12b. The stability and durability of the punching blade 13 would be improved by inserting part of the punching blade 13 into the through hole.

The support table 17 may be raised and lowered instead of the punching die 11.

The inclined surfaces 13c and 13d of the punching blade 13 may be formed by performing a known grinding method using a grinding stone or a lathe to grind an edge of a metal belt.

The punching blade 13 is not limited to the illustrated double-edged blade and may be a two-step blade having inclined surfaces 13c and 13d inclined in a stepped manner for two inclination angles. Further, the cutting edge 13a may be chamfered within a range that the cutting characteristics are not affected.

The punching die 11 may be cut out one or more holding seal members 15 from a single sheet of inorganic fiber mat 16.

The material for the support table 17 is not limited. Any material may be used as long as it is capable of supporting the inorganic fiber mat 16 in parallel and does not damage the cutting edges 13a. The material for the support table 17 may be, for example, a laminated body of a resin such as polypropylene resin, rubber, foam, or fibers, or a laminated body coated with such resin, rubber, foam, or fibers.

The holding seal member 15 may also be wound around a diesel particulate filter (DPF) in addition to the catalyst carrier 21.

The inclination angles θ1 and θ2 may be the same or different at different positions along the cutting edge 13a.

Examples of the preferred embodiment will now be described in more detail.

Blades having inclination angles θ1 and θ2 shown in table 1 were fixed to the base plate 12 to prepare the punching dies of test examples 1 to 6. The blade thickness was one millimeter. The durability of the punching die blades in test examples 1 to 6 was measured by carrying out the process described below.

Durability Test

The alumina fiber mat 16 was placed on the support table 17 and punched by each of the test examples 1 to 6 with the same pressure. The punching was repeated until at least one of the next abnormalities occurred. The abnormalities were categorized into abnormality 1—blade chipping or blade deformation, abnormality 2—imperfect cutting of holding seal member, and abnormality 3—difference between dimension of punched out holding seal member and initial dimension being one millimeter or greater (dimensional abnormality). The number of times of consecutive punching until the occurrence of an abnormality was counted. The results are shown in table 1.

TABLE 1

| | | | | Number of | |
|---|---|---|---|---|---|
| | | | | Times of | |
| | | | | Possible | |
| Test | Angle θ1 | Angle θ2 | \|θ1-θ2\| | Consecutive | Category of |
| example | (Degree) | (Degree) | (Degree) | Punching | abnormality |
| 1 | — | 17 | — | 50 | 1 and 3 |
| 2 | 3 | 17 | 14 | 100 | 3 |
| 3 | 10 | 17 | 7 | 2500 | 3 |
| 4 | 12 | 17 | 5 | >15000 | None |
| 5 | 17 | 17 | 0 | >30000 | None |
| 6 | 30 | 17 | 13 | 8500 | 2 |

From the result of table 1, it can be seen that the number of possible consecutive punching decreases when the difference between the inclination angles θ1 and θ2 exceeds ten degrees and the inclination angle of the two side surfaces 13e1 and 13e2 is excluded from the range of ten to thirty degrees. A dimensional abnormality (abnormality 1) occurred when the inclination angles θ1 and θ2 were less than ten degrees. Such results are believed to have been obtained due to the cutting edge bending and thereby displacing the cutting edge from its original position. Imperfect cutting occurred when the inclination angles θ1 and θ2 were greater than thirty degrees. Such a result is believed to have been obtained due to slight blade chipping greatly lowering the cutting capability. A decrease in the number of possible consecutive punching lowers the production efficiency for holding seal members.

The contents of JP-A-2001-316965 are incorporated herein by reference.

It should be apparent to those skilled in the art that the present invention may be embodied in many other specific forms without departing from the spirit or scope of the invention. Therefore, the present examples and embodiments are to be considered as illustrative and not restrictive, and the invention is not to be limited to the details given herein, but may be modified within the scope and equivalence of the appended claims.

What is claimed is:

1. A punching die for punching a sheet of an inorganic fiber mat to manufacture a holding seal member for winding around an exhaust gas purifier body, the punching die comprising:
a base plate; and
a double-edged punching blade, supported by the base plate, for punching the inorganic fiber mat to cut out the holding seal member.

2. The punching die according to claim 1, wherein the punching blade includes:
two side surfaces;
two inclination surfaces inclined relative to the two side surfaces; and
a cutting edge defined between the two inclined surfaces, wherein the two inclined surfaces are inclined at the same or different inclination angles.

3. The punching die according to claim 2, wherein the inclination angles of the two inclined surfaces are both about ten to about thirty degrees.

4. The punching die according to claim 2, wherein the difference between the inclination angles of the two inclined surfaces is about ten degrees or less.

5. The punching die according to claim 1, wherein the punching blade is made of carbon steel.

6. The punching die according to claim 1, wherein the inorganic fiber mat is made of alumina fibers.

7. The punching die according to claim 1, wherein the punching blade is lattice-shaped and cuts out a plurality of holding seal members from the inorganic fiber mat in a single punch.

8. The punching die according to claim 7, wherein the punching blade includes:
a plurality of parallel and straight longitudinal blades;
a plurality of lateral blades intersecting the longitudinal blades at a right angle and bent to form a tab and a socket for receiving the tab in each of the holding seal members, wherein the longitudinal blades and the lateral blades are welded together.

9. The punching die according to claim 8, wherein the plurality of longitudinal blades and the plurality of lateral blades have the same height.

10. A method for manufacturing a holding seal member for winding around an exhaust gas purifier body from a sheet of inorganic fiber mat, the method comprising:
forming a punching die by supporting a double-edged punching blade on a base plate; and
using the punching die to punch the inorganic fiber mat to form a holding seal member.

11. The method according to claim 10, wherein the punching blade includes:
two side surfaces;
two inclination surfaces inclined relative to the two side surfaces; and
a cutting edge defined between the two inclined surfaces, wherein the two inclined surfaces are inclined at the same or different inclination angles.

12. The method according to claim 11, wherein the inclination angles of the two inclined surfaces are both about ten to about thirty degrees.

13. The method according to claim 11, wherein the difference between the inclination angles of the two inclined surfaces is about ten degrees or less.

14. The method according to claim 10, wherein the punching blade is made of carbon steel.

15. The method according to claim 10, wherein the inorganic fiber mat is made of alumina fibers.

16. The method according to claim 10, wherein the punching blade is lattice-shaped and cuts out a plurality of holding seal members from the inorganic fiber mat in a single punch.

17. The method according to claim 16, wherein the punching blade includes:
a plurality of parallel and straight longitudinal blades;
a plurality of lateral blades intersecting the longitudinal blades at a right angle and bent to form a tab and a socket for receiving the tab in each of the holding seal members, wherein the longitudinal blades and the lateral blades are welded together.

18. The method according to claim 17, wherein the plurality of longitudinal blades and the plurality of lateral blades have the same height.
